(19) United States
(12) Patent Application Publication
(10) Pub. No.: US 2024/0178540 A1
(43) Pub. Date: May 30, 2024

(54) DIELECTRIC WAVEGUIDE

(71) Applicant: Siemens Healthcare GmbH, Erlangen (DE)

(72) Inventors: Peter Michael DUEPPENBECKER, Herzogenaurach (DE); Ralph TROMMER, Erlangen (DE); Andreas FACKELMEIER, Thalmaessing (DE); Christoph HOHL, Hahnbach (DE); Philipp QUEDNAU, Erlangen (DE)

(73) Assignee: Siemens Healthcare GmbH, Erlangen (DE)

(21) Appl. No.: 18/519,250

(22) Filed: Nov. 27, 2023

(30) Foreign Application Priority Data
Nov. 30, 2022 (DE) 10 2022 212 905.9

(51) Int. Cl. H01P 3/16; H01P 11/00

(52) U.S. Cl. CPC H01P 3/16; H01P 11/006

(57) ABSTRACT

A dielectric waveguide to transmit an electromagnetic signal, comprises: a first conductor region and a second conductor region. The first and second conductor regions extend along a longitudinal axis of the dielectric waveguide, wherein the first conductor region is formed from a first thermoplastic material and the second conductor region is formed from a second thermoplastic material. The first thermoplastic material has a higher effective permittivity than the second thermoplastic material.

### CROSS-REFERENCE TO RELATED APPLICATION (S)

The present application claims priority under 35 U.S.C. § 119 to German Patent Application No. 10 2022 212 905.9, filed Nov. 30, 2022, the entire contents of which is incorporated herein by reference.

### FIELD

One or more example embodiments of the present invention relate to a dielectric waveguide comprising at least two conductor regions, wherein both conductor regions are made of a thermoplastic material.

### BACKGROUND

Dielectric waveguides are used to guide and transmit electromagnetic waves. They exist alongside coaxial cables and metallic waveguides.

Coaxial lines consist of a metallic inner conductor and a concentrically arranged metallic outer conductor. These are separated from one another by a likewise concentrically arranged dielectric, wherein a useful signal power is transmitted via the dielectric. The surfaces of the metallic inner and outer conductor serve as a border for guiding the electromagnetic wave. Coaxial cables are suitable for transmitting broadband signals up to a frequency range of several GHz. Coaxial cables are unsuitable for a higher frequency range.

Hollow waveguides consist of a typically rectangular, round or elliptical metallic sheath that encloses a cavity used for wave propagation. The dimensions of the metallic sheath are matched to the frequency range of the electromagnetic signal to be transmitted, so that a traveling wave can form in the air-filled hollow interior of the conductor. Hollow waveguides exist for frequency ranges between a few GHz and several thousand GHz, but the respective transmittable bandwidth of the useful signal is severely limited.

In contrast, dielectric waveguides can be constructed entirely without electrically conductive materials. The guidance of an electromagnetic wave is defined solely by varying the dielectric conductivity (=permittivity, E) of the materials used perpendicular to the direction of propagation. The use of only dielectric materials enables the construction of waveguides with particularly low attenuation since ohmic conduction losses are avoided by not using electrically conductive materials. In particular, for radio-frequency applications in the giga, tera or optical frequency range, this reduces signal losses, which increases significantly with the signal frequency in metallic waveguides.

On the other hand, losses in a dielectric waveguide are mainly defined by the dielectric loss factor of the materials used.

The 1 GHz to 100 GHz frequency range is of great interest for broadband data communication since a large bandwidth and wide range of technically sophisticated electrical transmitters and receivers are available for data transmission in this range.

However, to date, there has been a lack of robust, low-loss waveguides for this frequency range that are easy and inexpensive to produce. Here, the main challenge is to combine the dielectric materials with sufficiently low dielectric losses in such a way that a variation of the dielectric conductivity in the radial direction is achieved and at the same time the mechanical requirements of the respective applications, for example with regard to fastening or stability of the waveguide, are met.

One specific field of application for dielectric waveguides in medical technology is bidirectional data communication between the rotor and stator of a computed tomography system. Bandwidths of up to 100 Gbit/s and more are required for the transmission of X-ray detector data, in particular in the rotor—stator direction. To date, sliding contacts have been used for this purpose, or the coupling for signal transmission has been realized by coaxial or capacitive conductor structures.

Dielectric waveguides are in principle very suitable for also transmitting a higher frequency spectrum via the transmission path. However, to date, there has been a lack of solutions for mechanically attaching a dielectric waveguide to the rotor of the computed tomography system in a low-loss and inexpensive manner without impairing the coupling properties between the rotating and stationary part. The mechanical connection of the dielectric waveguide to the rotor of the computed tomography system must, therefore, be particularly stable and robust, since the rotor rotates several times a second during operation and attachments must be able to meet corresponding centrifugal forces with a multiple of the acceleration due to gravity.

At present, the manufacture of dielectric waveguides is subject to the following requirements:

In principle, any dielectric is suitable as a waveguide, although there are large differences in terms of the dielectric loss factor. Gases or vacuum have an advantageously low dielectric loss factor, but are very difficult to shape or mechanically fasten without a corresponding compartment. Technically relevant dielectric materials are, therefore, primarily plastics and ceramics. Herein, plastics are particularly inexpensive and easy to shape via a variety of established industrial methods. The following plastics are of particular interest for the manufacture of waveguides, since they are characterized by sufficiently low dielectric losses: polystyrene (PS), polyethylene (PE), polypropylene (PP) and polytetrafluorethylene (PTFE). However, their permittivity is very similar, so that a sufficiently strong variation in permittivity in the radial direction of the conductor for effective signal conduction cannot be achieved with these materials per se.

### SUMMARY

It is known to vary the effective permittivity of a structure by combining several substances/materials with different permittivity. In particular, permittivity can be specifically reduced by including gases or a vacuum, for example producing a plastic foam. One known example of such a foam is expanded polystyrene (EPS), also known as Styrofoam. Foams can also be produced from other plastics, for example expanded polypropylene (EPP), or expanded polyethylene (EPE).

However, it is difficult to produce a material-bonded connection of the aforementioned plastics to one another. The problem with bonding is that the adhesives themselves cause high dielectric losses and the adhesive layers impair the waveguide's damping properties. On the other hand, thermoplastic bonds of said substances, in particular of the same plastics, are quite possible. A mechanical material-bonded connection is generally possible, but is limited by the shape of the waveguide and is complex to produce.

On the other hand, it is an object of embodiments of the present invention to provide a dielectric waveguide that can be produced simply and inexpensively and which is also designed for high mechanical stress. It is also an object of embodiments of the present invention to provide a dielectric waveguide with improved properties with respect to mechanical attachment in its operating position.

At least one or more of these objects are achieved by a dielectric waveguide, a transmission path comprising the dielectric waveguide and a production method for the dielectric waveguide according to the independent claims. Preferred and/or alternative, advantageous variants are the subject matter of the dependent claims.

The following describes the way at least an object is achieved according to embodiments of the present invention with respect to the claimed method and with respect to the claimed apparatuses. Features, advantages or alternative embodiments mentioned herein are likewise to be transferred to the other claimed subject matter and vice versa. In other words, features which are explained in connection with a method according to embodiments of the present invention can also be further developed with features which are described or claimed in connection with one of the apparatuses. Herein, the corresponding functional features of the method can in particular be embodied by corresponding substantive modules or units.

Therefore, embodiments of the present invention is based on a dielectric waveguide for transmitting an electromagnetic signal. The dielectric waveguide comprises:
a first conductor region and
at least one second conductor region.

The first and the second conductor region in each case extend along the longitudinal axis of the waveguide. The first and second conductor region are both formed from a first thermoplastic material or from a second thermoplastic material. Herein, the first thermoplastic material has a higher effective permittivity than the second thermoplastic material.

According to an embodiment of the present invention, a conductor region describes a part or a subregion of the dielectric waveguide that is involved in the propagation of an electromagnetic signal. In other words, an electromagnetic wave propagates at least in part in a conductor region or propagates at least in part via the conductor region. According to an embodiment of the present invention, therefore, the dielectric waveguide comprises at least two thermoplastic conductor regions, wherein, in some embodiments of the present invention, both conductor regions extend along the longitudinal extension of the waveguide. In particular, the conductor regions extend over the entire length of the waveguide. In some embodiments, interruptions can be provided in the conductor regions, for example in order to attach fastenings, coupling points or the like. The regions forming the interruptions can contain air so that wave propagation would be unaffected or only slightly affected. Herein, the longitudinal axis or the longitudinal extension describes the direction of signal propagation. Herein, the longitudinal extension of the dielectric waveguide is considerably greater than a transverse extension of the waveguide or one of the conductor regions.

In some embodiments of the present invention, more than two thermoplastic conductor regions are provided. In particular, further conductor regions can be formed by the ambient air, an ambient gas or vacuum.

Therefore, the air, gas or vacuum surrounding the dielectric waveguide can also contribute to the transmission of the electromagnetic signal and in this respect can be understood to be a third or further conductor region of the dielectric waveguide.

The dielectric waveguide according to an embodiment of the present invention is characterized in that the first and the second conductor region directly adjoin one another. Consequently, the two conductor regions are connected to one another. This can provide a form-fitting or material-bonded connection. Dispensing with additives for the connection makes this type of additive particularly advantageous in respect of signal loss during the transition of the electromagnetic wave from one conductor region to the other. In other words, signal attenuation at the interface can advantageously be reduced by a material-bonded connection or form-fitting connection of the two conductor regions.

Similarly, in some embodiments, the first and the second conductor region in each case directly adjoin the third conductor region formed by the ambient air.

As mentioned in the introduction, the effective permittivities of the first and second conductor region differ from one another in order to achieve effective signal propagation. For this purpose, in a preferred embodiment of the present invention, the second thermoplastic material is embodied as a foam. A foam is typically formed by introducing air, a gas or vacuum into a thermoplastic. Introducing a gaseous medium enables the effective permittivity of the second thermoplastic material to be adjusted, in particular reduced, compared to the first thermoplastic material. The higher the volume content of the introduced gas, the lower the effective permeability of the second thermoplastic material.

Particularly preferably, the second thermoplastic material is embodied as a foam of the first thermoplastic material. In other words, the second conductor region preferably consists of the foamed first thermoplastic material of the first conductor region. In this way, the first and the second conductor region can be joined together particularly easily, as will be described in detail below. This also has advantages with regard to the recyclability of the dielectric waveguide, since there is no need for laborious separation of the first and the second thermoplastic material from one another before preparation for reuse.

Particularly preferably, the first and the second conductor region are in each case embodied with a quadrangular cross section transverse to the direction of wave propagation, i.e., transverse to the longitudinal extension of the waveguide. Herein, a quadrangular cross section can, for example, be embodied in the form of a parallelogram, in particular a square, a rhombus or a rectangle or a trapezoid. With a quadrangular embodiment of the cross section of the conductor regions, the polarization of an electromagnetic wave in the conductor regions is advantageously determined or defined, thus achieving controlled wave propagation.

Herein, in some embodiments, the first conductor region is connected to the second conductor region on at least one outer side extending along the direction of propagation. This means that at least one outer side of the first conductor region and one outer side of the second conductor region are adjacent to one another or are connected to one another. In other words, in some embodiments of the present invention, the first and the second conductor region lie next to one another or one on top of the other. In other embodiments of the present invention, the first and the second and possibly further conductor regions are arranged concentrically around the common longitudinal axis of the dielectric waveguide. Therefore, here, the first conductor region is completely enclosed or sheathed by the second conductor region.

In further embodiments, the first and the second and possibly further conductor regions can alternatively also be embodied as round or ring-shaped and arranged concentrically around the common longitudinal axis of the dielectric waveguide. In these embodiments, the dielectric waveguide has a round or circular cross section transverse to the direction of propagation. Here, the first conductor region is again completely surrounded by the second conductor region in relation to its sheath surface.

In some embodiments of the present invention, the base surfaces of the first and second conductor region lying transverse to the direction of propagation have the same basic shape. In other words, the angles enclosed by two adjacent outer surfaces or the length ratios of adjacent outer sides between the first and second conductor region are embodied identically. For example, both conductor regions can be embodied as square or rectangular with the same side length ratios.

In particular, in embodiments with quadrangular first and second conductor regions arranged next to one another in the direction of propagation, it is advantageous according to the present invention for the second conductor region to be dimensioned larger than the first conductor region transverse to the direction of propagation. In this embodiment, the second conductor region acts as a support for the first conductor region. In other words, to produce the dielectric waveguide, the first conductor region is applied to the second conductor region. On the other hand, if sufficiently dimensioned, the first conductor region can also be used to attach or fix the dielectric waveguide. For example, the second conductor region can have molded-on holding elements, for example a groove or tongue extending along the longitudinal axis of the waveguide, by which the dielectric waveguide can be fixed to a corresponding counter-structure. In particular, the holding element can also be made from the second thermoplastic material, particularly preferably a foamed thermoplastic.

Preferred embodiments of the dielectric waveguide comprise a first and a second conductor region in which the base surfaces extending transversely to the direction of propagation have a side length ratio of between 1:7 to 1:13, particularly preferably 1:10 (in each case relating to the side length of the first and second conductor region). Here, the inventors have recognized that these dimensions of the conductor regions represent a good compromise with regard to sufficient stability of the waveguide and with regard to wave propagation behavior.

In a preferred embodiment of the dielectric waveguide, the first conductor region has an extension transverse to the direction of propagation in the range between 0.2 mm to 10 mm.

Herein, the second conductor region has, for example, an extension transverse to the direction of propagation in the range of 0.2 cm to 5 cm. According to embodiments of the present invention, these dimensions are particularly suitable for use in a rotor of a computed tomography system.

In order to be able to use inexpensive and readily available materials in the manufacture of the dielectric waveguide, in preferred embodiments of the present invention, the first and/or the second thermoplastic material are made of at least one material from the list of the following materials in the form of polymers or copolymers thereof: polystyrene, polypropylene, polyethylene, polytetrafluorethylene. In other words, in a preferred embodiment, both the first and second thermoplastic material are made of only one of said materials. Consequently, in a preferred embodiment, the first and second thermoplastic material are made of one and the same plastic, for example once as a solid plastic and once as a foam. In particular, in this embodiment, the first and second conductor region can be joined together particularly easily. For example, the first and the second conductor region can both be formed from polystyrene or polypropylene.

Permittivity, also called dielectric conductivity or dielectricity, indicates the polarization capacity of a material through electric fields. Here, a distinction can be made between effective permittivity and relative permittivity. While relative permittivity describes polarization capacity specific to a certain substance, effective permittivity represents the polarization capacity of a material consisting of different substances. Herein, the effective permittivity results from the relative permittivities of the individual components of the composite material and is determined by the volume contents of the substances comprised. For a material comprising only one substance, the effective permittivity is the relative permittivity of the one substance.

Particularly good, because it is low-loss, signal transmission can be achieved if the effective permittivities of the first and second thermoplastic material have a ratio of between 1:2 and 1:10. Since the values for permittivity can vary with the frequency of the signal to be transmitted, the permittivity ratio should apply for a frequency range of from 50 GHz to 100 GHz, in particular for a frequency range of. Herein, the second thermoplastic material preferably has an effective permittivity below 1.1. This means that the effective permittivity of the second thermoplastic material is very close to that of air or vacuum. The effective permittivity of the first thermoplastic material is then preferably in the range of 2 to 2.5. This is in particular the case when the first thermoplastic material is embodied as one of the aforementioned materials.

In some embodiments, the dielectric waveguide according to the present invention is characterized in that the first thermoplastic material for forming the first conductor region is processed via one of the following methods: 3D printing, injection molding, casting, welding, for example radio-frequency welding, ultrasonic welding, laser welding. In a particularly preferred embodiment, the first thermoplastic material is applied to the second thermoplastic material by one of the above methods.

In the context of the present invention, the application of the first thermoplastic material to the second conductor region should be understood as connecting the first thermoplastic material to the second thermoplastic material.

3D printing, also referred to as additive manufacturing (AM) or generative manufacturing encompasses all manufacturing methods in which a material is applied layer-by-layer to form a three-dimensional object. Layer-by-layer construction takes place using one or more liquid or solid materials according to specified dimensions and shapes, wherein physical or chemical curing or melting processes take place to strengthen each individual layer. In particular, according to an embodiment of the present invention, the first thermoplastic material of the first conductor region can be printed onto the second conductor region. In this embodiment, the second conductor region forms the substrate for the printing process. Here, the connection between the first and second conductor region is achieved by fusion.

Injection molding should be understood to mean primary molding methods in which a material, mainly in the form of a plastic, is liquefied and injected under pressure into a mold, the injection mold. Cooling or a crosslinking reaction causes the material to return to the solid state with a new shape. On the other hand, during casting the liquefied plastic is poured into a mold without pressure and cures in the mold. Common to both these embodiments is the fact that the casting mold can in each case, at least in regions, be formed by the first conductor region comprising the second thermoplastic material or can comprise this. Here, once again, the connection between the first and second conductor region is achieved by fusion.

During welding, high energy is introduced into a plastic at least in regions or locally via radio-frequency radiation, ultrasound or laser light and this leads to heating or melting of the first thermoplastic material. If the energy is introduced into the first thermoplastic material at the interface between the first conductor region and the second conductor region, here, once again, the conductor regions are fused at the interface.

In some embodiments of the present invention, the dielectric waveguide can be characterized in that the first conductor region is first created or formed by one of the following methods: 3D printing, casting or injection molding and is then applied to the second conductor region by welding.

In an alternative embodiment of the present invention, the dielectric waveguide is characterized in that the first thermoplastic material is foamed onto or into the second thermoplastic material during foaming of the second thermoplastic material. The second thermoplastic material can be foamed by adding either a physical or a chemical propellant to the liquefied thermoplastic. While physical propellants evaporate due to temperature, chemical propellants release a gas, typically nitrogen, through decomposition. Gas inclusions form in the liquid thermoplastic. In this state, cooling and solidification take place. Either during foaming or only during solidification, the first, typically preformed, conductor region is brought into spatial proximity of the resulting foam in order in this way to connect the two conductor regions to one another.

The present invention is further based on a transmission path for contactless transmission of an electromagnetic signal from a first device part of a data-generating device to a second device part of the device via electromagnetic coupling. This transmission path comprises at least one dielectric waveguide, preferably more dielectric waveguides, according to an embodiment of the present invention of the type described in the introduction at the first and/or second device part.

A data-generating device should be understood as being a device in which data is generated electronically. In particular, the data is generated by a physical measurement process and/or interaction process of, or with, the environment of the device. Here, the measurement or interaction is preferably carried out by the first device part and further data processing is carried out on the second device part. In some embodiments, the first and second device part of the data-generating device can move relative to one another during operation, for example, during operation of the data-generating device, the second device part can be fixed relative to its environment as intended, while the first device part moves relative to the second device part and hence also relative to the environment in the same way.

In this respect, in a preferred embodiment, the data-generating device is a computed tomography system and the first device part is the rotor and the second device part is the stator of the computed tomography system.

The term transmission path is intended to encompass an apparatus comprising at least two parts, wherein at least one part of the apparatus is to be arranged on the first device part and on the second device part in each case, and which is configured to enable data to be transmitted from the first device part to the second device part via a physical process.

Electromagnetic coupling encompasses any coupling which is substantially based on electromagnetic processes. In this sense, the dielectric waveguide according to an embodiment of the present invention forms a coupler attached to one of the device parts, which is configured to establish a connection for transmitting the electromagnetic signal at a sufficiently small distance via an electromagnetic coupling to a further physically identical coupler of the other device part in each case. In this context, the coupling strength should in particular be understood to mean the intensity of the electromagnetic interaction between the coupler that establishes the coupling and which is in turn reflected in the intensity of the signal that is transmitted by the relevant coupling from a coupler acting as a transmitter to a coupler acting as a receiver.

A sufficiently short distance is required for electromagnetic coupling for contactless transmission of the at least one electromagnetic signal. Hence, coupling preferably takes place via a distance dimension between the first coupler and the second coupler that is several orders of magnitude smaller than the dimensions of the data-generating device. Depending on this frequency, this distance is in the range of 0.1 mm to a few centimeters.

In some embodiments of the present invention, the transmission path is configured for optimized, since it is low-loss, transmission of an electromagnetic signal for a frequency range of from 10 GHz to 500 GHz, preferably for 50 GHz to 70 GHz, in particular for a frequency range around 60 GHz. Thus, the transmission path according to an embodiment of the present invention is configured to realize particularly fast contactless and loss-free data transmission even for computed tomography systems with photon-counting-radiation detectors.

In a further aspect, the present invention also relates to a method for producing a dielectric waveguide. The method comprises a series of steps. However, the order of the steps is not defined by the order in which they are enumerated. In particular, in some embodiments of the present invention, steps can be performed in parallel or interleaved with one another.

A first step is directed at forming a first conductor region from a first thermoplastic material. A second step relates to forming a second conductor region from a second thermoplastic material.

In a third step, the first and second conductor region are joined by connecting the first conductor region to the second conductor region on at least one outer side extending along the direction of propagation.

As already mentioned in the introduction with reference to the dielectric waveguide according to an embodiment of the present invention, in particular the steps of forming the waveguide can take place via a method that is known per se: 3D printing, injection molding and/or casting. A forming step can simultaneously comprise the step of joining, for example, if, during a casting or injection molding method, in each case the other conductor region is arranged in the casting mold or, at least in regions, embodies this. In some embodiments, the forming of one of the conductor regions can comprise foaming of a thermoplastic material.

In some embodiments of the present invention, a step of joining the two conductor regions can comprise welding, for example laser welding or ultrasonic welding. In an alternative embodiment of this step, joining the two conductor regions can comprise foaming a thermoplastic material for forming one of the conductor regions, wherein during the foaming, joining to the other conductor region takes place at the same time in that the latter is at least partially foamed-in.

### BRIEF DESCRIPTION OF THE DRAWINGS

The above-described properties, features and advantages of this invention and the manner in which these are achieved will become clearer and more plainly comprehensible in conjunction with the following description of the exemplary embodiments explained in more detail in conjunction with the drawings. This description does not restrict the present invention to these exemplary embodiments. In different figures, the same components are given identical reference symbols. The figures are generally not to scale. The figures show:

FIG. 1 a perspective view of a dielectric waveguide in an exemplary embodiment,

FIG. 2 a perspective view of a dielectric waveguide in a further exemplary embodiment,

FIG. 3 a view of a method according to the present invention for manufacturing a dielectric waveguide in an exemplary embodiment, and

FIG. 4 a schematic representation of a data-generating device comprising a transmission path according to the present invention in an exemplary embodiment.

### DETAILED DESCRIPTION

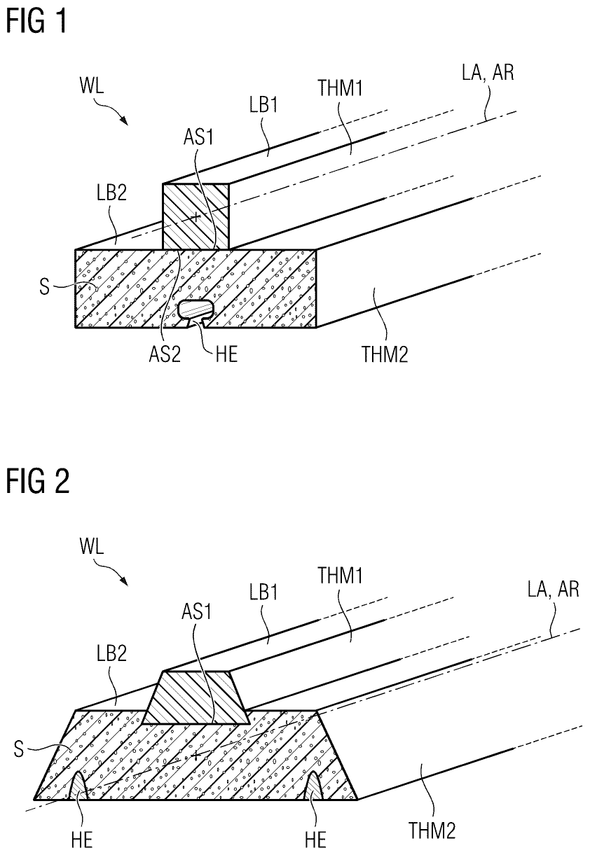

FIG. 1 shows a perspective view of a dielectric waveguide WL in an exemplary embodiment of the present invention. The waveguide WL is used to transmit an electromagnetic signal, preferably to transmit a signal between a plurality of device parts of a data-generating device in which the electromagnetic signal is coupled from one waveguide (part) to a further waveguide (part). The dielectric waveguide completely dispenses with metallic components and is, therefore, also not subject to the ohmic conduction losses of a metallic conductor.

The waveguide WL comprises at least one first conductor region LB1 and one second conductor region LB2. In particular, the ambient air may form a third conductor region which is also involved in the signal propagation. The first and second conductor region LB1, LB2 both extend along the longitudinal axis LA of the waveguide WL. The longitudinal axis LA of the waveguide simultaneously also describes the direction of wave propagation AR of the waveguide, i.e., the direction in which the electromagnetic wave propagates through the waveguide. Both conductor regions extend over the entire length of the waveguide. The first conductor region LB1 is formed from a first thermoplastic material THM1 and the second conductor region LB2 is formed from a second thermoplastic material THM2. Herein, the first thermoplastic material is selected such that it has a higher effective permittivity than the second thermoplastic material.

In FIG. 1, the second thermoplastic material THM2 is embodied as a foam S of the first thermoplastic material THM1. Consequently, in this case, only one starting material is used for both conductor regions, for example polystyrene. This not only simplifies procurement during production, it also improves the waveguide's recyclability. Alternatively, the first and the second thermoplastic material can also be different from one another.

The conductor regions LB1, LB2 of the waveguide WL have a quadrangular cross section, i.e., transverse to the direction of wave propagation AR. While FIG. 1 illustrates a square cross section for both conductor regions, FIG. 2, which is likewise a perspective view of a dielectric waveguide WL in another exemplary embodiment, shows a trapezoidal cross-sectional shape of both conductor regions. Obviously, other cross-sectional shapes of the conductor regions are also conceivable and within the spirit of the present invention. In particular, the two conductor regions do not have to have corresponding cross-sectional shapes, but can be embodied differently from one another.

In the present case, the first conductor region LB1 and the second conductor region LB2 are connected to one another on at least one outer side AS1, AS2 extending along the direction of wave propagation (AR). Here, the connection is embodied as a material-bonded connection.

In both variants of FIGS. 1 and 2, the cross section of the second conductor region LB2 is larger in area than the cross section of the first conductor region LB1. This, on the one hand, enables a more stable and more robust embodiment of the waveguide, which, for example, has to withstand strong rotation-induced forces in a rotor 6 of a computed tomography system. On the other hand, the larger cross section of the second conductor region also provides space for the integration of holding elements HE with which the dielectric waveguide can be attached to a support structure, for example the rotor 6. As can be identified in FIG. 1, a holding element HE in the form of a fixing groove can then be formed directly during the forming of the second conductor region LB2. The dielectric waveguide can then be mounted simply by plugging it into or clicking it onto the fixing groove. This reduces the overall number of components required for mounting the waveguide and reduces the effort required for installation. Alternatively, holding elements HE in the form of threaded sleeves, through-holes or other receptacles for fastening elements can be introduced or formed at the same time as the forming of the second conductor region, as is further illustrated in FIG. 2. Further embodiments of the holding elements HE are also conceivable and in the spirit of the present invention.

In one exemplary embodiment variant, the first conductor region LB1 is embodied with an extension transverse to the direction of wave propagation AR of 0.5 mm, 1 mm, 2 mm, or 4 mm. Herein, the second conductor region LB2 is embodied with an extension transverse to the direction of wave propagation of 0.5 cm, 1 cm, 2 cm, 2.5 cm or 3 cm.

As already mentioned in the introduction, the effective permittivity of the first thermoplastic material THM1 is greater than that of the second thermoplastic material THM2. Therefore, the first conductor region LB1 guides a signal more efficiently than the second conductor region LB2. In the present case, the effective permittivity of the first conductor region has a value of 2, whereas the effective permittivity of the second conductor region is around 1.

In order to achieve the described permittivity values for the first conductor region LB1, the following materials are particularly suitable as the first thermoplastic material: polystyrene, polypropylene, polyethylene, polytetrafluorethylene. These are all characterized by easy processability and formability.

The dielectric waveguide WL shown in FIGS. 1 and 2 is furthermore characterized by its manufacturing method. When forming the first conductor region LB1, the first thermoplastic material THM1 is namely formed via one of the following joining methods and in particular also applied to the second thermoplastic material THM2 by such a method, i.e., joined thereto: 3D printing, injection molding, casting, welding, for example radio-frequency welding, ultrasonic welding, laser welding. In embodiments of the present invention that are not shown, the second conductor region LB2 can also be produced by one of the above methods. Alternatively or additionally, the waveguide can be characterized in that, during foaming of the second thermoplastic material THM2, the first thermoplastic material THM1 is foamed onto or into the second thermoplastic material. Accordingly, FIG. 2 shows that the outer side AS1 of the first conductor region LB1 protrudes slightly into the outer side AS2 of the second conductor region LB2. Therefore, here, the foam S of the second conductor region LB2 also extends slightly upward on the outer sides of the first conductor area LB1 which are shown running from bottom to top. In this sense, the connection between the two conductor regions in the embodiment shown in FIG. 2 is a form-fitting connection.

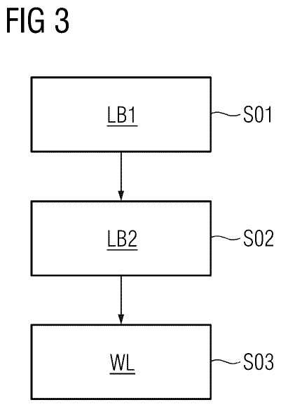

For further details relating to the production of the dielectric waveguide WL, reference is also made to the embodiments in FIG. 3.

FIG. 3 shows a view of a method according to the present invention for producing a dielectric waveguide WL in an exemplary embodiment. In a first step S01, a first conductor region LB1 is formed from a first thermoplastic material THM1. In a second step S02, a second conductor region LB2 is formed from a second thermoplastic material THM2. In a third step S03, the first and second conductor region are joined together by connecting the first conductor region to the second conductor region LB2 at an outer side AS1, AS2 extending along the direction of wave propagation AR. Steps S01 and S02 preferably comprise a thermoplastic forming method such as injection molding or casting. Alternatively, it is possible to use a 3D printing method. At least one of the two conductor regions LB1, LB2 can also be formed by foaming from a thermoplastic material. Steps S01 and S02 are used to shape the first or second conductor region LB1, LB2 as desired, in particular in a square basic shape.

Step S03 is used to connect the two conductor regions to one another. Herein, the connection is a form-fitting or material-bonded connection. Herein, a material-bonded connection is preferable in respect of simplified manufacturing. Step S03 can also comprise foaming a thermoplastic material. Herein, the conductor region first formed by foaming is also simultaneously attached to the other conductor region during forming in that this is at least partially foamed. In this respect, the steps S01, S02 and S03 are to be regarded as independent method steps, which can, however, be executed in parallel, combined with one another or interleaved with one another, depending on the embodiment.

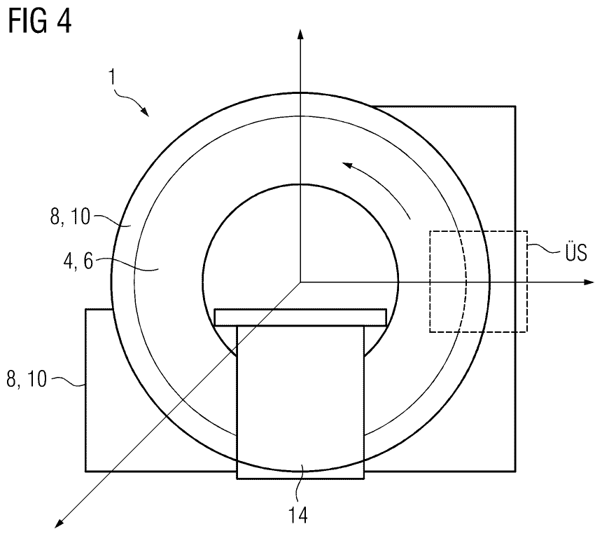

FIG. 4 is a schematic representation of a data-generating device 1 in cross section comprising a transmission path US according to the present invention in an exemplary embodiment. The data-generating device 1 is embodied as a computed tomography system. This comprises a first device part 4 which is formed by the rotatably mounted rotor 6 forming the gantry of the computed tomography system and a second device part 8 which is formed by the stator 10 comprising a holding frame for the rotor 6. During operation of the computed tomography system, the rotor 6 performs a rotational movement about the axis 12 which is fixed with respect to the holding frame 10. Herein, a patient bench 14 that also belongs to the data-generating device 1 is arranged such that, if possible, a patient lies on the axis 12. Components for medical imaging, for example an X-ray source and an X-ray detector, are arranged in the gantry, in particular in the rotor 6. These are not shown in more detail in FIG. 4. For example, the image data generated via the X-ray detector, but also control data or the like, is now to be transmitted via the transmission path US arranged on the rotor 6 and stator 10. The image data can then be converted into the form of an electromagnetic signal and, for example, forwarded to an image processing unit that is not shown in further detail by which it is further processed. The stator 10 has a first transmission unit or a first coupler of the transmission path US, while the rotor 6 has a second transmission unit or a second coupler of the transmission path Us. In the present case, these transmission units are in each case formed by a dielectric waveguide, for example as shown in FIG. 1 or 2, or comprise such a waveguide. The signal transmission or the coupling of the transmission units is contactless.

The transmission units formed via the dielectric waveguide are designed to transmit electromagnetic signals, preferably in a frequency range of from 10 GHz to 500 GHZ, particularly preferably in the range around 60 GHZ, with a high bandwidth and low losses.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element (s) or feature (s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention was illustrated in more detail and described by the preferred exemplary embodiment, the present invention is not restricted by this exemplary embodiment. Other variations can be derived here from by the person skilled in the art without departing from the scope of protection of the present invention.

What is claimed is:

1. A dielectric waveguide to transmit an electromagnetic signal, the dielectric waveguide comprising:
a first conductor region; and
a second conductor region; wherein
the first conductor region and the second conductor region extend along a longitudinal axis of the dielectric waveguide,
the first conductor region is formed from a first thermoplastic material and the second conductor region is formed from a second thermoplastic material, and
the first thermoplastic material has a higher effective permittivity than the second thermoplastic material.

2. The dielectric waveguide of claim 1, wherein the second thermoplastic material is a foam of the first thermoplastic material.

3. The dielectric waveguide of claim 1, wherein the first conductor region and the second conductor region have a quadrangular cross section transverse to a direction of wave propagation.

4. The dielectric waveguide of claim 1, wherein the first conductor region is connected to the second conductor region on at least one outer side extending along a direction of wave propagation.

5. The dielectric waveguide of claim 1, wherein the second conductor region is dimensioned larger than the first conductor region transverse to a direction of wave propagation.

6. The dielectric waveguide of claim 1, wherein the first conductor region has an extension transverse to a direction of wave propagation in a range between 0.2 mm to 10 mm.

7. The dielectric waveguide of claim 1, wherein the second conductor region has an extension transverse to a direction of wave propagation in a range of 0.5 cm to 5 cm.

8. The dielectric waveguide of claim 1, wherein permittivities of the first thermoplastic material and the second thermoplastic material have a ratio of between 1:2 and 1:10.

9. The dielectric waveguide of claim 1, wherein at least one of the first thermoplastic material or the second thermoplastic material is comprised of at least one of polymers, copolymers or variants thereof, including polystyrene, polypropylene, polyethylene, or polytetrafluorethylene.

10. The dielectric waveguide claim 1, wherein the first thermoplastic material is applied to the second thermoplastic material to form the first conductor region by one of 3D printing, injection molding, casting, radio-frequency welding, ultrasonic welding, or laser welding.

11. The dielectric waveguide of claim 1, wherein the first thermoplastic material is foamed onto or into the second thermoplastic material during foaming thereof.

12. A transmission path for contactless transmission of an electromagnetic signal from a first device part of a data-generating device to a second device part of the data-generating device by electromagnetic coupling, the transmission path comprising:
a dielectric waveguide as claimed in claim 1 at at least one of the first device part or the second device part.

13. The transmission path as claimed in claim 12, wherein the data-generating device is a computed tomography system, the first device part is a rotor of the computed tomography system and the second device part is a stator of the computed tomography system.

14. The transmission path as claimed in claim 12, wherein the transmission path is configured for low-loss transmission of an electromagnetic signal in a frequency range of 10 GHz to 500 GHz.

15. A method for producing a dielectric waveguide, the method comprising:
forming a first conductor region from a first thermoplastic material;
forming a second conductor region from a second thermoplastic material; and
joining the first conductor region and the second conductor region by connecting the first conductor region to the second conductor region on an outer side extending along a direction of wave propagation.

16. The dielectric waveguide of claim 2, wherein the first conductor region and the second conductor region have a quadrangular cross section transverse to a direction of wave propagation.

17. The dielectric waveguide of claim 16, wherein the first conductor region is connected to the second conductor region on at least one outer side extending along a direction of wave propagation.

18. The dielectric waveguide of claim 2, wherein the first thermoplastic material is foamed onto or into the second thermoplastic material during foaming thereof.

19. The dielectric waveguide of claim 6, wherein the second conductor region has an extension transverse to the direction of wave propagation in a range of 0.5 cm to 5 cm.

20. The dielectric waveguide claim 1, wherein the first thermoplastic material is applied to the second thermoplastic material to form the first conductor region by one of 3D printing, injection molding, casting, or welding.
